(19) United States
(12) Patent Application Publication
(10) Pub. No.: US 2009/0307047 A1
(43) Pub. Date: Dec. 10, 2009

(54) System to Defer and Refer Advertisements Presented in Conjunction with Media Device Control Interfaces

(75) Inventors: Thomas E. Cook, Essex Junction, VT (US); Peter G. Finn, Brampton (CA); Martin G. Kienzle, Briarcliff Manor, NY (US); Paul B. Moody, Hyde Park, VT (US)

Correspondence Address: HAMILTON, BROOK, SMITH & REYNOLDS, 530 VIRGINIA ROAD, PO BOX 9133, CONCORD, MA, 01742-9133, US

(73) Assignee: International Business Machines Corporation, Armonk, NY (US)

(21) Appl. No.: 12/131,565

(22) Filed: Jun. 2, 2008

(51) Int. Cl. G06Q 30/00

(52) U.S. Cl. 705/10; 705/14.55

(57) ABSTRACT

A targeted advertising method and system tracks user interaction with and responses to a displayed advertisement. The advertisement is displayed in the user viewing control interface of a media device system (e.g. delivering cable television, satellite television, global computer network/online media). Based on recorded user responses, the invention system generates viewer lists enabling targeted advertising. The viewer lists include lists of users that have viewed the advertisement, lists of users that have requested more information and/or lists of peer recommended users.

### BACKGROUND

In the art of advertising, an “impression” is a unit of viewing by or exposure to an audience. Advertisers pay substantially more for ‘targeted’ impressions. Advertising targeting is usually based on some demographics such as regional location or, gender, income, etc of the intended audience/recipients.

### BRIEF SUMMARY

With the present invention, applicants provide two new types of high value ‘targeting’ of advertising recipients. In the invention media device design, television users are presented ads as part of the user control experience (channel guide, PVR listings, etc.). In the present invention, the system allows users to ‘recommend’ the ad for others in their ‘social circle’. The invention system records both the referring user and the recipient of the forwarded advertisement. This information is then made available to the advertising systems. Referring viewers can be rewarded by the advertisers (loyalty campaign) and Recipient viewers are identified as highly qualified by the ‘referring viewers’. Access to the qualified recipient viewers is sold at a premium relative to otherwise unidentified viewers.

In some embodiments, a method and system of advertising comprise: (a) providing an advertisement to a user in a media system, the advertisement being displayed in user viewing control screen views; (b) tracking user interaction with the displayed advertisement, including user response to the displayed advertisement; and (c) generating viewer lists based on the tracked user responses. The viewer lists enable targeted advertising.

The user viewing control screen views include any of: option menus, electronic program guides and recoding lists.

The user response to the displayed advertisement may include any of: a request for more information to be currently displayed; a request for the advertisement information for later viewing; and a recommendation to have the advertisement transmitted to another user.

The generated viewer lists may include a list of users that have viewed the advertisement, a list of users that requested more information, and/or a list of peer recommended users.

The media system is part of or formed of any of: a cable television network; a satellite television network; and a global computer network.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a media device system embodying the present invention.

FIG. 2 is a schematic view of a computer network in which the FIG. 1 embodiment of the present invention operates.

FIG. 3 is a block diagram of a computer node in the network of FIG. 2.

FIG. 4 is a flow diagram of an embodiment of the present invention.

### DETAILED DESCRIPTION

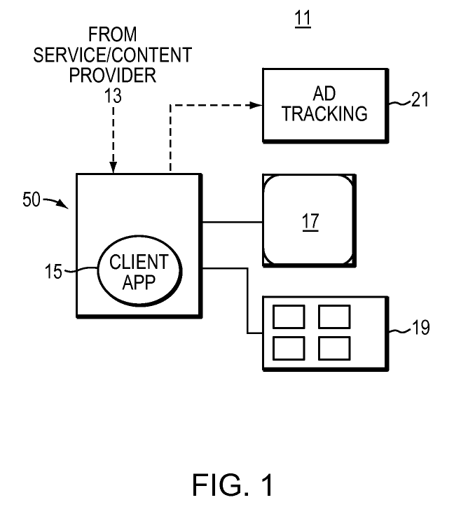

Illustrated in FIG. 1 is an example embodiment (media device system) 11 of the present invention. Content or service provider 13 feeds or otherwise provides media to client 50 typically in a network of clients. Example content/service providers 13 are cable television networks, satellite television networks/services, internet (online) sources or other global computer network content or service providers and so forth.

Client 50 is operatively coupled for communication with content/service provider 13 and other servers 21, and includes digital processing capabilities as further made clear below. Generally, in response to media received from content/service provider 13, client 50 supports display (or other rendering) of the media on an output device (e.g. television, display monitor, speakers, etc.) 17. A viewer (user) interacts with and controls the display using input devices 19 such as a television or set top controller, a keyboard, cursor control device and the like. Through the input device/controller 19, the user operates channel selection, volume setting, time shifting features (i.e. recording) and other viewing control operations common in the art. Such operations are typically accomplished through option menus, electronic program guides and recording listings and similar user-interactive dialog boxes and screen views.

Turning now to the features and operation of the present invention, media system 11 further operates as follows.

TV viewers using the invention media device system 11 are shown advertisements during their TV viewing control actions (in option menus, electronic program guides, personal video recorder listings, etc.). In one embodiment, the viewer is given three options if he chooses to act on the displayed advertisements. The first option is to have a message (the advertisement) sent to his electronic message box for later viewing (the message will contain substantially more information on the advertised offer). A second option is to view the advertisement offer in more detail now (currently). A third option allows the viewer to ‘recommend’ the advertisement to a second viewer. For example, the second viewer receives an electronic message similar to the one sent to the first viewer in the view-later option.

In all three options, the viewer's actions are recorded and used to develop blind lists of viewers who have seen the advertisement, chosen to receive more info at the time of viewing or in the form of a message for reading later, or have recommended the advertisement to another viewer. In one embodiment, this is accomplished by a client application 15 and an ad tracker 21 as follows.

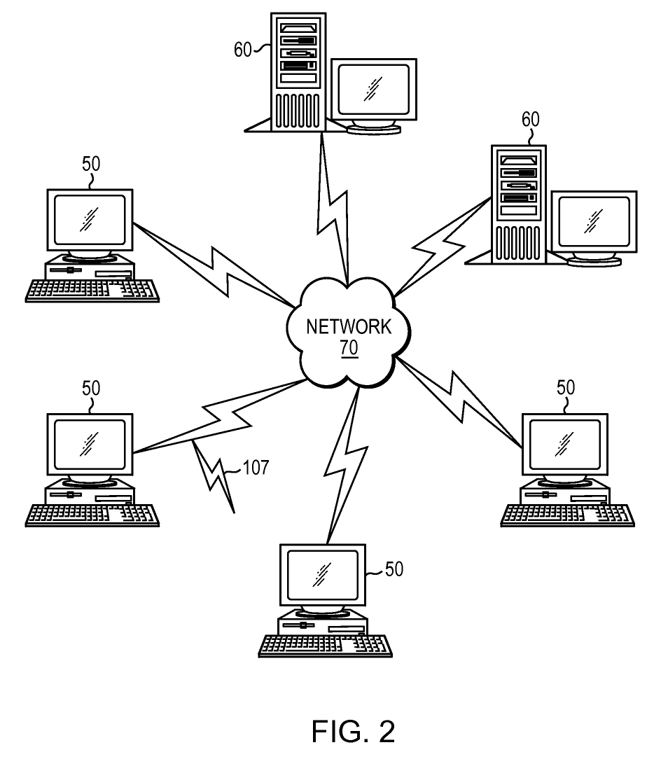

Client application 15 monitors the display of advertisements in the system's control dialogs, screen views and/or menus. Client application 15 monitors the request for more information (either for reading now or via user electronic message box for reading later) and the recommending of an advertisement for another viewer. The client system 50 uploads this data (generated by the monitoring) to an advertising tracking server 21. The ad tracker 21 may reside in either the client device 50 or one or more servers 60 (FIG. 2).

The tracking server 21 generates a list of viewers that have viewed the advertisements (unqualified impressions), a list of viewers that have requested more information (inquiries) and a list of viewers that have been recommended (qualified referrals). Also in the tracking server 21, there is associated with each viewer a record of adverts seen, inquired about or recommended. When a viewer requests more information, the viewer is shown a webpage like advertisement, or if the request was for a deferred message, the webpage like advertisement is stored in the viewer's electronic message inbox for later viewing.

When a viewer recommends an advertisement to another viewer, ad tracker 21 informs the advertiser about both the referring viewer and recipient of the recommendation. The identity of the recipient viewers are not released but can be used by advertisers to target advertisements to the targeted viewer. The recommending viewer's identity is or may be revealed to the advertisers so that loyalty promotion programs can be updated.

FIG. 2 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

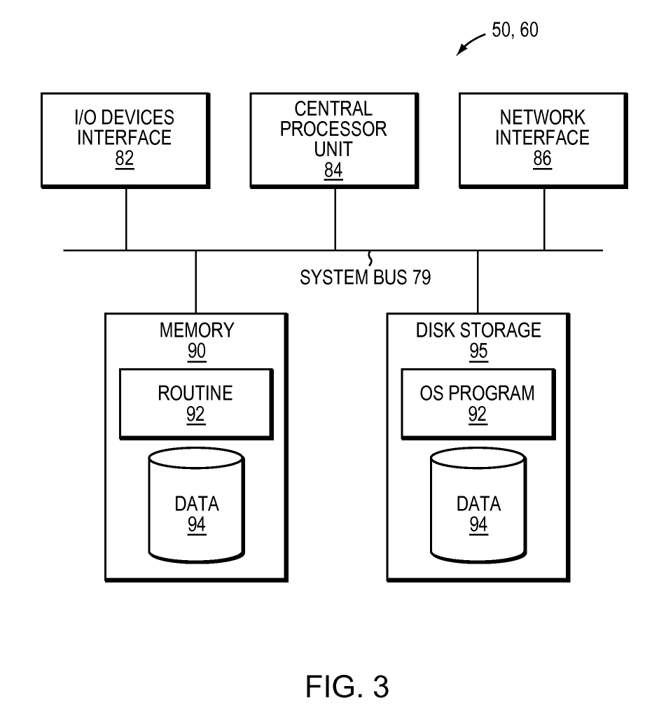

FIG. 3 is a diagram of the internal structure of a computer (e.g., client processor/device 50 or server computers 60) in the computer system of FIG. 2. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 2). Memory 90 provides volatile storage for computer software instructions 92 and data 94 used to implement an embodiment of the present invention (e.g., client application 15 and ad tracker 21 and supporting code detailed above and below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above and below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

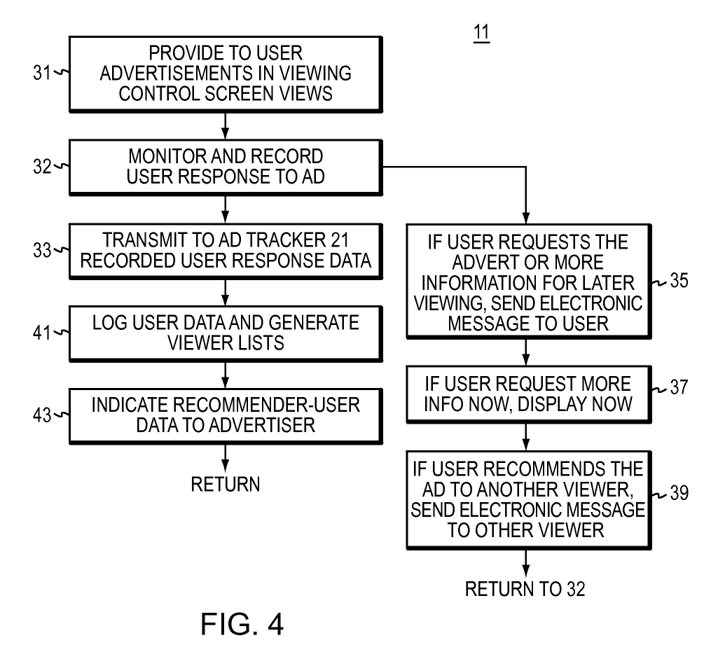

Referring now to FIG. 4, an example flow diagram of embodiments of the present invention is illustrated. In step 31, media system 11 provides to an end user one or more advertisements during control screen views (e.g. in option menus, electronic program guides, video recorders listings, and in dialog boxes and the like). This includes providing indications of user response options. In effect the advertisements are displayed as part of the user viewing-control interface.

In step 32, client application 15 monitors and records end user response to the displayed ads. If the user's response includes a request for more information steps 35 and 37 may be executed. That is, step 37 provides current display of the requested information. Step 35 sends an electronic message to the end user (his electronic message queue) for later viewing of the requested more information.

If the end user response in step 32 includes a recommendation to another viewer, then step 39 transmits the electronic message to the electronic message box of the recommended viewer.

After monitoring and recording user responses to presented ads, client application 15 (at step 33) transmits the recorded user response data to ad tracker 21. Multiple client applications 15 throughout the network of media users/viewers transmit respective user response data to ad tracker 21. In turn, ad tracker 21 logs the various user response data and generates viewer lists (step 41). In particular, at step 41 ad tracker 21 (i) generates a list of viewers that have viewed the advertisements, (ii) generates a list of viewers that requested more information, and (iii) generates a list of recommended viewers. These lists are made available to advertising systems and enable improved targeting of adverts.

Ad tracker 21 further tracks and lists recommending user's data for advertiser use. This data includes the referring user's name (identity) and indication of the recipient of the recommendation/referral.

Other data is suitable and in the purview of one skilled in the art given the foregoing description.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of advertising comprising:
providing an advertisement to a user in a media system, the advertisement being displayed in user viewing control screen views;
tracking user interaction with the displayed advertisement, including user response to the displayed advertisement; and
generating viewer lists based on the tracked user responses, the viewer lists enabling targeted advertising.

2. A method as claimed in claim 1 wherein the user viewing control screen views include any of: option menus, electronic program guides and recording lists.

3. A method as claimed in claim 1 wherein the step of tracking includes:
recording user responses; and
transmitting recorded user responses to a tracking member, the tracking member generating the viewer lists.

4. A method as claimed in claim 1 wherein user response to the displayed advertisement includes any of:
a request for more information to be currently displayed;
a request for the advertisement information for later viewing; and
a recommendation to have the advertisement transmitted to another user.

5. A method as claimed in claim 1 wherein the viewer lists include a list of users that have viewed the advertisement.

6. A method as claimed in claim 1 wherein the viewer lists include a list of users that requested more information.

7. A method as claimed in claim 1 wherein the viewer lists include a list of peer recommended users.

8. A method as claimed in claim 7 wherein respective recommending user is identified.

9. A computer system comprising:
a server providing an advertisement to a user of a media system, the advertisement being displayed effectively as part of a user viewing control interface;
a client recording user response to the displayed advertisement; and
a tracking member coupled to receive recorded user response data from the client and generating viewer lists based on the recorded user response data, the viewer lists enabling targeted advertising.

10. A computer system as claimed in claim 9 wherein the advertisement is displayed in user viewing control screen views.

11. A computer system as claimed in claim 10 wherein the user viewing control screen views include any of: option menus, electronic program guides and recording lists.

12. A computer system as claimed in claim 9 wherein user response to the displayed advertisement includes any of:
a request for more information to be currently displayed;
a request for the advertisement information for later viewing; and
a recommendation to have the advertisement transmitted to another user.

13. A computer system as claimed in claim 9 wherein the viewer lists include a list of users that have viewed the advertisement.

14. A computer system as claimed in claim 9 wherein the viewer lists include a list of users that requested more information.

15. A computer system as claimed in claim 9 wherein the viewer lists include a list of recommended users.

16. A computer system as claimed in claim 15 wherein respective recommending user is identified.

17. A computer system as claimed in claim 9 wherein the server is part of any of:
a cable television network,
a satellite television service, and
a global computer network content provider.

18. An advertising system comprising:
an advertisement displayed effectively as part of a user viewing control interface in a media device system;
a media device member recording user response to the displayed advertisement; and
a tracking member responsive to the recorded user responses and generating viewer lists based on user responses, the viewer lists enabling targeted advertising.

19. An advertising system as claimed in claim 18 wherein the user viewing control interface includes any of: option menus, electronic program guides and recording lists.

20. An advertising system as claimed in claim 18 wherein the media device system is part of any of:
a cable television network;
a satellite television network; and
a global computer network.

21. A computer program product for targeted advertising, the computer program product comprising:
a computer useable medium having computer useable program code embodied therewith, the computer usable program code comprising:
computer usable program code configured to (a) track user interaction with an advertisement displayed in user viewing control interface of a media system, and (b) generate viewer lists based on the tracked user interaction, the viewer lists enabling targeted advertising.
